(19) United States
(12) Patent Application Publication
(10) Pub. No.: US 2021/0033193 A1
(43) Pub. Date: Feb. 4, 2021

(54) SEAL MEMBER AND WATERPROOF STRUCTURE

(71) Applicant: Yazaki Corporation, Tokyo (JP)

(72) Inventor: Eiji Aoki, Shizuoka (JP)

(21) Appl. No.: 16/940,342

(22) Filed: Jul. 27, 2020

(30) Foreign Application Priority Data
Jul. 29, 2019 (JP) 2019-138465

(51) Int. Cl. F16J 15/02

(52) U.S. Cl. CPC F16J 15/022

(57) ABSTRACT

A seal member includes: a main body elastically deformable by an external force, and a first seal part that is pressed against a sealing surface of a first member to tightly seal between the main body and the first member. The first seal part includes: a plurality of protrusions formed to project toward the first member in a compression direction and to be separated from each other in an orthogonal direction; and an opening provided to a base part between the neighboring protrusions and directed in a vertical direction. The main body includes a housing space that communicates with outside via the opening and houses a liquid adhesive. The opening maintains a closed state in an uncompressed state of the main body, and deforms from the closed state to an open state to allow the adhesive to leak from the housing space to a space between the neighboring protrusions.

### CROSS-REFERENCE TO RELATED APPLICATION(S)

The present application claims priority to and incorporates by reference the entire contents of Japanese Patent Application No. 2019-138465 filed in Japan on Jul. 29, 2019.

### BACKGROUND OF THE INVENTION

### 1. Field of the Invention

The present invention relates to a seal member and a waterproof structure.

### 2. Description of the Related Art

As a conventional seal member, there is an annular seal packing made of rubber, having an annular groove formed continuously in the length direction in the center of the surface to be in contact with an aluminum diecast (for example, see Japanese Patent Application Laid-open No. 2010-244976).

When fixing a seal packing to an adhesion target, there are a method of fitting the seal packing into a groove formed on the adhesion target side and a method of fixing the seal packing to the adhesion target using holding pins, for example. In the former case, a plurality of press-fit ribs are formed along both side faces of the seal packing, and the seal packing is fitted into the groove formed on the adhesion target side to be fixed. In the latter case, a plurality of tongues having pin holes are formed on both side faces of the seal packing, and the pin holes are fitted into the holding pins formed on the adhesion target side to be fixed.

As for the seal packing, it is necessary to finish the product by removing unnecessary portions (burrs) from a rubber molding product that is vulcanized by using a metal mold. In the methods described above, deburring by punching is difficult, and therefore, an adhesive is directly applied to the seal packing and adheres to the target member without forming the press-fit ribs and the tongues.

When an adhesive is applied to a seal packing in assembly work, a step and equipment for applying the adhesive to the seal packing are required, which may result in increasing the cost. Furthermore, some adhesives have adhesiveness that changes due to changes in the temperature, humidity, etc. Therefore, management of those is required, and there is still a room for improvement.

### SUMMARY OF THE INVENTION

The present invention is designed in view of the foregoing issues, and an object of the present invention is to provide a seal member and a waterproof structure capable of reducing steps for applying and managing adhesives and the like in assembly work of the seal member.

A seal member according to one aspect of the present invention includes a main body elastically deformable by an external force, the main body being disposed between a first member and a second member opposing to each other; and a first seal part that is formed by being extended in an extending direction of the main body and opposing to the first member in a compression direction of the main body, and is pressed against a sealing surface of the first member to tightly seal between the main body and the first member, wherein the first seal part includes a plurality of protrusions formed to project toward the first member in the compression direction and to be separated from each other in an orthogonal direction orthogonal to the extending direction, and one or more opening provided to a base part between the protrusions neighboring to each other and directed in a vertical direction; the main body includes one or more housing space that communicates with outside via the opening and houses a liquid adhesive; and the opening maintains a closed state in an uncompressed state of the main body, and deforms from the closed state to an open state in a compressed state where the first seal part is pressed against a sealing surface of a target-side member and the main body is compressed in the compression direction to allow the adhesive to leak from the housing space to a space between the protrusions neighboring to each other.

According to another aspect of the present invention, it is preferable that the seal member further includes a second seal part that is formed by being extended in the extending direction of the main body and opposing to the second member in the compression direction, and is pressed against a sealing surface of the second member to tightly seal between the main body and the second member, wherein the second seal part includes a convex face formed to project toward the second member in the compression direction by being curved toward an outer side.

According to still another aspect of the present invention, in the seal member, it is preferable that the opening and the housing space are formed by being extended in the extending direction of the main body.

According to still another aspect of the present invention, in the seal member, it is preferable that the adhesive is housed in the housing space while being encapsulated inside a spherical body that is ruptured by an external force, the sealing surface of the first member includes a projection that is formed by being projected toward the first seal part in the compression direction and extended in the extending direction of the main body, a tip of the projection is located inside the spherical body housed in the housing space in the compression state, and the opening deforms from the closed state to the open state in the compressed state to allow the adhesive to leak from the housing space to the space between the projections neighboring to each other.

According to still another aspect of the present invention, in the seal member, it is preferable that the adhesive is housed in the housing space while being encapsulated inside a spherical body that is ruptured by an external force, the sealing surface of the first member includes projections that are formed by being projected toward the first seal part in the compression direction and being separated therebetween in the extending direction of the main body, tips of the projections are located inside the spherical body housed in the housing space in the compression state, and the opening deforms from the closed state to the open state in the compressed state to allow the adhesive to leak from the housing space to the space between the projections neighboring to each other.

According to still another aspect of the present invention, in the seal member, it is preferable that the seal member is formed in an annular shape.

A waterproof structure according to still another aspect of the present invention includes the seal member, wherein the seal member is disposed between the first member and the second member opposing to each other to tightly seal between the first member and the second member.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a perspective view illustrating an appearance of a seal member according to an embodiment;

FIG. 2 is a sectional view illustrating a schematic configuration of the seal member according to the embodiment;

FIG. 3 is a schematic view illustrating an example of an injection method of an adhesive for the seal member according to the embodiment;

FIG. 4 is a sectional view illustrating a schematic configuration of a waterproof structure according to the embodiment;

FIG. 5 is a sectional view illustrating a schematic configuration of the waterproof structure according to the embodiment;

FIG. 6 is a schematic view illustrating an example of a loading method of an encapsulated adhesive for a seal member according to a modification example of the embodiment;

FIG. 7 is a schematic view illustrating an example of a projection formed on a sealing surface of a first member according to the modification example of the embodiment;

FIG. 8 is a schematic view illustrating another example of the projection formed on the sealing surface of the first member according to the modification example of the embodiment; and

FIG. 9 is a sectional view illustrating a schematic configuration of a seal member according to the modification example of the embodiment.

### DETAILED DESCRIPTION OF THE PREFERRED EMBODIMENTS

Hereinafter, an embodiment of a seal member and a waterproof structure according to the present invention will be described in detail by referring to the accompanying drawings. Note, however, that the present invention is not limited to the embodiment illustrated hereinafter. Furthermore, it is to be noted that structural elements in the following embodiment include elements that can be easily replaced by those skilled in the art or elements considered substantially the same.

### Embodiment

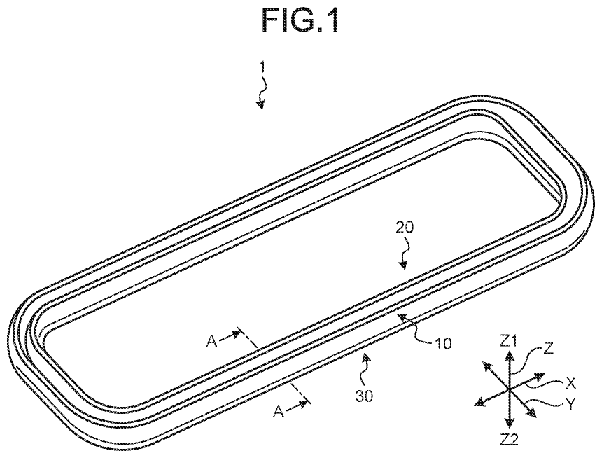

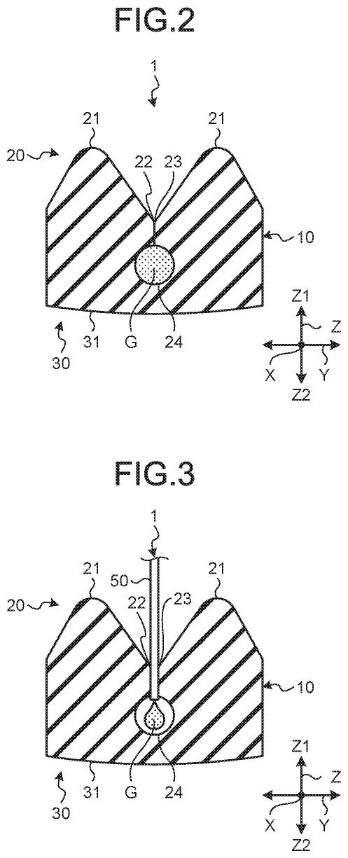

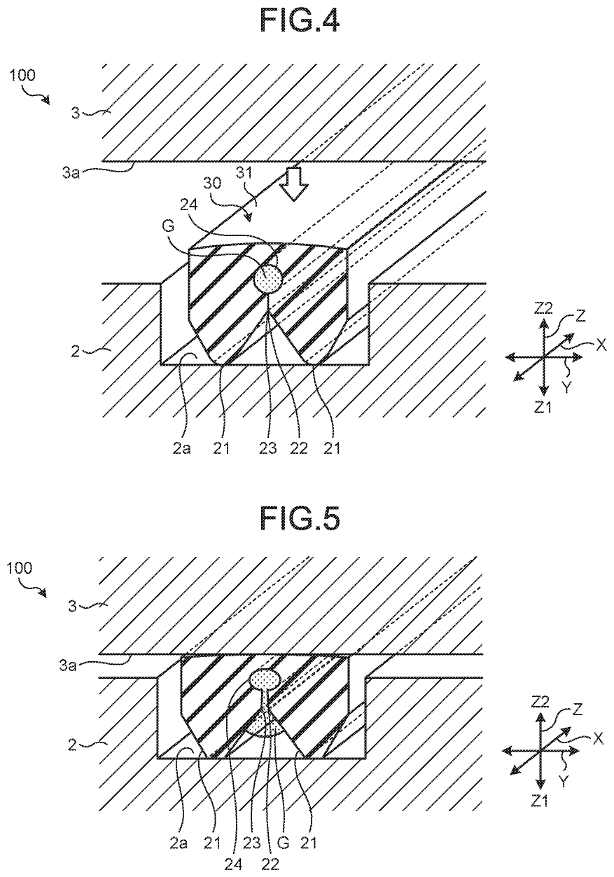

The seal member and the waterproof structure according to the embodiment will be described. FIG. 1 is a perspective view illustrating an appearance of the seal member according to the embodiment. FIG. 2 is a sectional view illustrating a schematic configuration of the seal member according to the embodiment. FIG. 3 is a schematic view illustrating an example of an injection method of an adhesive for the seal member according to the embodiment. FIG. 4 is a sectional view illustrating a schematic configuration of the waterproof structure according to the embodiment. FIG. 5 is a sectional view illustrating a schematic configuration of the waterproof structure according to the embodiment. Note that FIG. 2 and FIG. 3 (including FIG. 9) are the sectional views taken along A-A of FIG. 1.

Note that X-direction in the drawings is defined as the major-axis direction of the seal member of the embodiment. Y-direction is defined as the minor-axis direction of the seal member of the embodiment, which is the direction orthogonal to the major-axis direction. Z-direction is defined as a compression direction of the seal member of the embodiment, which is the direction orthogonal to the major-axis direction and the minor-axis direction. As for the Z-direction, Z1-direction is defined as a first direction, and Z2-direction is defined as a second direction. Specifically, the Z2-direction illustrated in FIG. 1 to FIG. 3 and FIG. 6 to FIG. 8, and the Z1-direction illustrated in FIG. 4 to FIG. 5 (including FIG. 9) are defined as the vertical direction.

As illustrated in FIG. 1, a seal member 1 of the embodiment is a seal packing formed in an annular shape, for example. The seal member 1 is formed with an elastically deformable elastic material that can be easily processed and has oil resistance as well as water resistance, such as a synthetic rubber or a thermoplastic elastomer. As illustrated in FIG. 4 and FIG. 5, the seal member 1 is disposed between a first member 2 and a second member 3 opposing to each other, and tightly seals between the first member 2 and the second member 3 to configure a waterproof structure 100. The first member 2 and the second member 3 are a resin housing that configures an apparatus mounted on a vehicle such as an automobile, for example. The seal member 1 prevents intrusion of gases and liquids (water, oil, and the like) into the first member 2 and the second member 3 in a state where the first member 2 and the second member 3 are physically connected. The seal member 1 of the embodiment includes a main body 10, a first seal part 20, and a second seal part 30.

The main body 10 is disposed between the first member 2 and the second member 3 opposing to each other, and configured to be elastically deformable by an external force. As for the main body 10, as illustrated in FIG. 2 and FIG. 3, the sectional shape when viewed from an extending direction is in a recessed shape with a part of rectangle being dented to the inner side. The main body 10 is formed by being extended in the extending direction. The main body 10 includes a housing space 24 that communicates with outside via an opening 23 provided to the first seal part 20 and houses a liquid adhesive G. The housing space 24 is formed by being extended in the extending direction of the main body 10. The adhesive G of the embodiment is a one-component liquid adhesive. The adhesive G is injected from the outside via the opening 23, and stays in the housing space 24 in an uncompressed state of the main body 10. The adhesive G leaks from the opening 23 to the outside of the housing space 24 in a compressed state of the main body 10 and bonds the seal member 1 with the first member 2. It is possible to change the adhesive G according to the material of an adhesion target (for example, the first member 2). Note here that the compressed state of the main body 10 is a state where the first seal part 20 is pressed against a sealing surface 2a of the target-side member (the first member 2) and the main body 10 is compressed in the compression direction. In the main body 10, in regards to the compression direction, the first seal part 20 is provided in the first direction while the second seal part 30 is provided in the second direction.

The first seal part 20 is formed by being extend in the extending direction of the main body 10 and opposing to the first member 2 in the compression direction of the main body 10, and is pressed against the sealing surface 2a of the first member 2 to tightly seal between the main body 10 and the first member 2. The first seal part 20 includes two protrusions 21 and the opening 23.

The two protrusions 21 are formed to project toward the first member 2 in the compression direction of the main body 10 and to be separated from each other in an orthogonal direction orthogonal to the extending direction of the main body 10. The tip of each of the protrusions 21 in the compression direction is defined with a curvature, and configured to be elastically deformable by an external force. Each of the protrusions 21 is formed by being extended in the extending direction of the main body 10, and the two protrusions 21 and a base part 22 formed between the neighboring protrusions 21 configure a recessed shape dented into the inner side.

The opening 23 is formed by being extended in the extending direction of the main body 10, provided to the base part 22 between the neighboring protrusions 21, and directed in the vertical direction. The opening 23 maintains a closed state in the uncompressed state of the main body 10. The opening 23 deforms from the closed state to an open state in the compressed state.

The second seal part 30 is formed by being extended in the extending direction of the main body 10 and opposing to the second member 3 in the compression direction of the main body 10, and is pressed against a sealing surface 3a of the second member 3 to tightly seal between the main body 10 and the second member 3. The second seal part 30 includes a convex face 31 formed to project toward the second member 3 in the compression direction by being curved toward the outer side. The convex face 31 is formed by being extended in the extending direction of the main body 10.

Next, an injection method for injecting the adhesive G into the housing space 24 of the seal member 1 will be described by referring to FIG. 3. First, an operator sets the seal member 1 on a fixing table (not illustrated) such that the first seal part 20 is directed in the first direction. Then, the operator inserts a dispenser 50 into the opening 23 of the first seal part 20. At this time, the dispenser 50 is inserted into the opening 23 that is maintaining a closed state, and advances in the second direction such that its tip in the second direction is located inside the housing space 24 of the main body 10. Then, the operator injects the liquid adhesive G into the housing space 24 from a device, not illustrated, via the dispenser 50. It is preferable to dispose a plurality of the dispensers 50 in the extending direction with a space provided therebetween because the housing space 24 is formed by being extended in the extending direction.

Next, a leak method of the adhesive G in a compressed state of the seal member 1 will be described by referring to FIG. 4 and FIG. 5. The operator places the seal member 1 on the first member 2. The seal member 1 is placed in the recessed part having the sealing surface 2a of the first member 2 as the base part. At this time, the two protrusions 21 of the seal member 1 come in contact with the sealing surface 2a of the first member 2, so that the tips thereof are elastically deformed to some extent by the weight of the seal member 1. However, since the main body 10 is in an uncompressed state, the opening 23 maintains the closed state so that there is no leakage of the adhesive G from the housing space 24.

Then, the operator brings down the second member 3 toward the first member 2 from the second direction to the first direction. As for the seal member 1, when the second seal part 30 abuts against the sealing surface 3a of the second member 3 and is gradually compressed in the compression direction, the two protrusions 21 are elastically deformed in the direction orthogonal to the compression direction so that a contact area contacting with each other when the opening 23 is in the closed state becomes gradually smaller. Furthermore, since the housing space 24 becomes gradually crushed, the internal pressure of the housing space 24 is gradually increased, and therefore, the liquid adhesive G inside the housing space 24 gradually leaks from the opening 23 with the reduced contact area to the outside to seek escape. The adhesive G leaked out from the opening 23 runs along outer wall faces of the neighboring protrusions 21 in the first direction and reaches the sealing surface 2a of the first member 2. The adhesive G is gradually set by leaking out from the housing space 24 and contacting the air, thereby bonding the seal member 1 with the first member 2.

As described above, the seal member 1 and the waterproof structure 100 include: the main body 10 that is elastically deformable by an external force; and the first seal part 20 that is pressed against the sealing surface 2a of the first member 2 to tightly seal between the main body 10 and the first member 2. The first seal part 20 includes: the protrusions 21 that are formed to project toward the first member 2 in the compression direction and to be separated from each other in the orthogonal direction; and the opening 23 provided to the base part 22 between the neighboring protrusions 21 and directed in the vertical direction. The main body 10 includes the housing space 24 that communicates with outside via the opening 23 and houses the liquid adhesive G. The opening 23 maintains the closed state in the uncompressed state of the main body 10, and deforms from the closed state to the open state in the compressed state to allow the adhesive G to leak from the housing space 24 into a space between the neighboring protrusions 21.

With the above-described configuration, the adhesive G is housed in the housing space 24 of the seal member 1 having the opening 23 that is closed in the uncompressed state, and leaks from the opening 23 to the outside when the seal member 1 is in the compressed state to bond the seal member 1 with the first member 2. As a result, since the adhesive G is housed inside the seal member 1, in an assembly process of the seal member 1, for example, it is unnecessary to provide a step and equipment for applying the adhesive G to the seal member 1 so that the manufacturing cost and the like can be reduced. Furthermore, when the adhesive G is injected into the housing space 24, the adhesive G does not easily contact the air because the opening 23 is closed in the uncompressed state, so that it is possible to suppress setting and the like of the adhesive G, for example. As a result, work and the like for managing the temperature and humidity of the adhesive G become unnecessary, so that it is possible to reduce manufacturing cost and the like. Furthermore, since the adhesive G is housed in the tightly sealed housing space 24 within the seal member 1, there is no concern about adhesion of the seal members 1 to each other by the adhesive G. Thus, it is not necessary to individually pack the seal members, so that the number of components and manufacturing cost can be reduced.

Furthermore, the seal member 1 of the embodiment further includes the second seal part 30 that is formed to oppose to the second member 3 in the compression direction and pressed against the sealing surface 3a of the second member 3 to tightly seal between the main body 10 and the second member 3. The second seal part 30 has the convex face 31 formed to project toward the second member 3 by being curved toward the outer side. With this configuration, when the seal member 1 shifts from the uncompressed state to the compressed state, the second seal part 30 is elastically deformed because of contact-pressure of the second member 3 so that the housing space 24 can be efficiently compressed from the second direction side.

Furthermore, in the seal member 1 of the embodiment, the opening 23 and the housing space 24 are formed by being extended in the extending direction of the main body 10, so that it is possible to apply the adhesive G substantially uniformly between the sealing surface 2a of the first member 2 and the first seal part 20 of the seal member 1 in the extending direction of the main body 10.

### Modification Examples of Embodiment

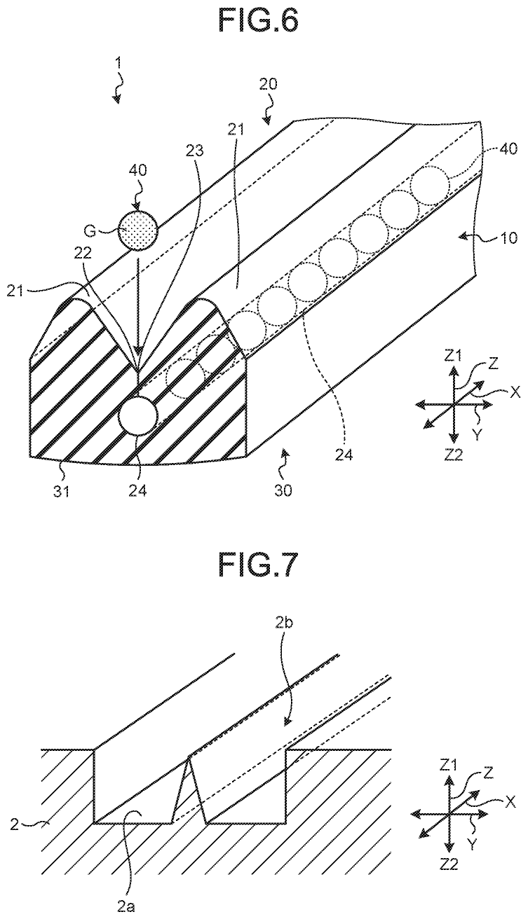

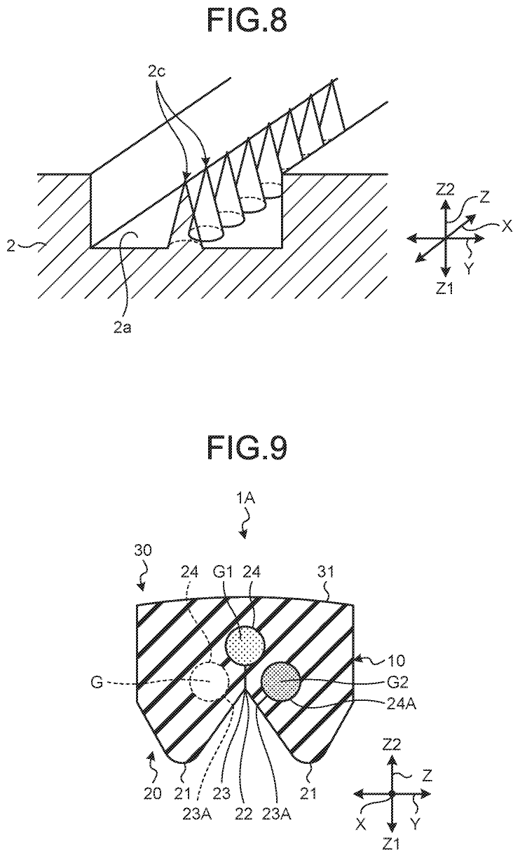

Not limited to the case of the embodiment where the adhesive G is directly housed in the housing space 24, the adhesive G may be housed in the housing space 24 while being encapsulated in a capsule 40, for example. FIG. 6 is a schematic view illustrating an example of a loading method of an encapsulated adhesive for the seal member according to a modification example of the embodiment. FIG. 7 is a schematic view illustrating an example of the projection formed on the sealing surface of the first member according to the modification example of the embodiment. FIG. 8 is a schematic view illustrating another example of the projection formed on the sealing surface of the first member according to the modification example of the embodiment.

The capsule 40 according to the modification example of the embodiment is an example of a spherical body, and it is configured to be ruptured by an external force (FIG. 6). The capsule 40 is made of a resin material or the like, for example, and encloses the liquid adhesive G inside thereof. A plurality of the capsules 40 are prepared and housed in the housing space 24 (FIG. 6). The external diameter of the capsule 40 is substantially the same as the internal diameter of the housing space 24, for example. The capsules 40 are disposed in the extending direction of the housing space 24 with a space provided therebetween or disposed without any space, for example. The capsules 40 are housed in the housing space 24 in the uncompressed state of the seal member 1. In the compressed state of the seal member 1, the capsules 40 are ruptured by a tip in the second direction of a projection 2b or tips in the second direction of projections 2c formed on the sealing surface 2a of the first member 2.

As illustrated in FIG. 7, the projection 2b is formed to project toward the first seal part 20 in the compression direction and to extend in the extending direction of the main body 10. The projection 2b is formed to have a triangular sectional shape when viewed from the extending direction. The projection 2b is formed in a triangular prism shape. The projection 2b of the embodiment is formed to have a sectional shape of an isosceles triangle when viewed from the extending direction. The tip of the projection 2b is configured to locate inside the capsules 40 housed in the housing space 24 in the compressed state. As for the projection 2b, the tip on the second direction side is formed to have an acute angle so as to be able to easily rupture the capsules 40.

As illustrated in FIG. 8, the projections 2c are formed to project toward the first seal part 20 in the compression direction with a space provided therebetween in the extending direction of the main body 10. Each of the projections 2c is formed in a cone shape. The projection 2c is formed to have a triangular sectional shape when viewed from the extending direction. The projection 2c of the embodiment is formed to have a sectional shape of an isosceles triangle when viewed from the extending direction. The tips of the projections 2c are configured to locate inside the capsules 40 housed in the housing space 24 in the compressed state, as in the case of the projection 2b. As for the projections 2c, the tips on the second direction side are formed to have an acute angle so as to be able to easily rupture the capsules 40.

As in the case of the embodiment described above, the opening 23 of the modification example changes its shape from the closed state to the open state in the compressed state to allow the adhesive G to leak from the housing space 24 into the space between the neighboring protrusions 21.

The seal member 1 according to the modification example houses the adhesive G encapsulated in the capsules 40 in the housing space 24, so that it is possible to suppress solidification of the adhesive G by contacting the air. Furthermore, since the capsules 40 can be housed in the housing space 24 via the opening 23 without using the dispenser 50, it is possible to suppress damage to the opening 23 caused by the dispenser 50, for example.

While the liquid adhesive G of the embodiment described above is a one-component adhesive, the adhesive is not limited thereto but may be a two-component adhesive. FIG. 9 is a sectional view illustrating a schematic configuration of a seal member according to a modification example of the embodiment. In a seal member 1A according to the modification example, the first seal part 20 has a plurality of openings 23 and 23A provided to the base part 22 between the neighboring protrusions 21 and directed in the vertical direction. As for the seal member 1A, the main body 10 includes: the housing space 24 that communicates with outside via the opening 23 and houses the liquid adhesive G1; and a housing space 24A that communicates with outside via the opening 23A and houses a liquid adhesive G2. The opening 23A is formed in the extending direction of the main body 10, and disposed in the vicinity of the opening 23. The adhesive G2 is injected into the housing space 24A via the dispenser 50 inserted into the opening 23A. The openings 23 and 23A maintain the closed state in the uncompressed state of the main body 10. The openings 23 and 23A change their shapes from the closed state to the open state in the compressed state to allow the adhesives G1 and G2 to leak from the housing spaces 24 and 24A into the space between the neighboring protrusions 21. The adhesives G1 and G2 leaked from the openings 23 and 23A are mixed and set in the space between the neighboring protrusions 21 to bond the first member 2 with the seal member 1.

In the modification example, as illustrated in FIG. 9, the housing space 24A is formed on one side of the orthogonal direction (Y-direction) out of the two protrusions 21. However, the housing space 24A is not limited thereto but may be formed on the other side of the orthogonal direction (24A illustrated with a broken line).

Furthermore, not limited to the case of the above-described modification example where the one-component adhesive G is loaded in the capsules 40, it is also possible to load two-component adhesives G1 and G2 in a separate state. In that case, the capsules 40 housed in the housing space 24 are ruptured by the projections 2b and 2c formed on the sealing surface 2a of the first member 2 in the compression state. As a result, the adhesive G1 and the adhesive G2 within the capsules 40 leak from the opening 23 into the space between the neighboring protrusions 21, and those are mixed and set to bond the first member 2 and the seal member 1.

While the first seal part 20 of the embodiment and the modification examples described above includes the two protrusions 21 formed to project toward the first member 2 in the compression direction and to be separated from each other in the orthogonal direction, the first seal part 20 is not limited thereto. For example, the first seal part 20 may include two or more protrusions 21 that are formed to project toward the first member 2 in the compression direction and to be separated from each other in the orthogonal direction.

The seal member and the waterproof structure according to the present embodiment provide the effect that it is possible to reduce the steps for applying and managing the adhesive and the like in assembly work of the seal member.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A seal member, comprising:
a main body elastically deformable by an external force, the main body being disposed between a first member and a second member opposing to each other; and
a first seal part that is formed by being extended in an extending direction of the main body and opposing to the first member in a compression direction of the main body, and is pressed against a sealing surface of the first member to tightly seal between the main body and the first member, wherein
the first seal part includes
a plurality of protrusions formed to project toward the first member in the compression direction and to be separated from each other in an orthogonal direction orthogonal to the extending direction, and
one or more opening provided to a base part between the protrusions neighboring to each other and directed in a vertical direction;
the main body includes one or more housing space that communicates with outside via the opening and houses a liquid adhesive; and
the opening maintains a closed state in an uncompressed state of the main body, and deforms from the closed state to an open state in a compressed state where the first seal part is pressed against a sealing surface of a target-side member and the main body is compressed in the compression direction to allow the adhesive to leak from the housing space to a space between the protrusions neighboring to each other.

2. The seal member according to claim 1, further comprising:
a second seal part that is formed by being extended in the extending direction of the main body and opposing to the second member in the compression direction, and is pressed against a sealing surface of the second member to tightly seal between the main body and the second member, wherein
the second seal part includes a convex face formed to project toward the second member in the compression direction by being curved toward an outer side.

3. The seal member according to claim 1, wherein
the opening and the housing space are formed by being extended in the extending direction of the main body.

4. The seal member according to claim 2, wherein
the opening and the housing space are formed by being extended in the extending direction of the main body.

5. The seal member according to claim 1, wherein
the adhesive is housed in the housing space while being encapsulated inside a spherical body that is ruptured by an external force,
the sealing surface of the first member includes a projection that is formed by being projected toward the first seal part in the compression direction and extended in the extending direction of the main body,
a tip of the projection is located inside the spherical body housed in the housing space in the compression state, and
the opening deforms from the closed state to the open state in the compressed state to allow the adhesive to leak from the housing space to the space between the projections neighboring to each other.

6. The seal member according to claim 2, wherein
the adhesive is housed in the housing space while being encapsulated inside a spherical body that is ruptured by an external force,
the sealing surface of the first member includes a projection that is formed by being projected toward the first seal part in the compression direction and extended in the extending direction of the main body,
a tip of the projection is located inside the spherical body housed in the housing space in the compression state, and
the opening deforms from the closed state to the open state in the compressed state to allow the adhesive to leak from the housing space to the space between the projections neighboring to each other.

7. The seal member according to claim 3, wherein
the adhesive is housed in the housing space while being encapsulated inside a spherical body that is ruptured by an external force,
the sealing surface of the first member includes a projection that is formed by being projected toward the first seal part in the compression direction and extended in the extending direction of the main body,
a tip of the projection is located inside the spherical body housed in the housing space in the compression state, and
the opening deforms from the closed state to the open state in the compressed state to allow the adhesive to leak from the housing space to the space between the projections neighboring to each other.

8. The seal member according to claim 1, wherein
the adhesive is housed in the housing space while being encapsulated inside a spherical body that is ruptured by an external force,
the sealing surface of the first member includes projections that are formed by being projected toward the first seal part in the compression direction and being separated therebetween in the extending direction of the main body,
tips of the projections are located inside the spherical body housed in the housing space in the compression state, and
the opening deforms from the closed state to the open state in the compressed state to allow the adhesive to leak from the housing space to the space between the projections neighboring to each other.

9. The seal member according to claim 2, wherein
the adhesive is housed in the housing space while being encapsulated inside a spherical body that is ruptured by an external force,
the sealing surface of the first member includes projections that are formed by being projected toward the first seal part in the compression direction and being separated therebetween in the extending direction of the main body,
tips of the projections are located inside the spherical body housed in the housing space in the compression state, and
the opening deforms from the closed state to the open state in the compressed state to allow the adhesive to leak from the housing space to the space between the projections neighboring to each other.

10. The seal member according to claim 3, wherein
the adhesive is housed in the housing space while being encapsulated inside a spherical body that is ruptured by an external force,
the sealing surface of the first member includes projections that are formed by being projected toward the first seal part in the compression direction and being separated therebetween in the extending direction of the main body,
tips of the projections are located inside the spherical body housed in the housing space in the compression state, and
the opening deforms from the closed state to the open state in the compressed state to allow the adhesive to leak from the housing space to the space between the projections neighboring to each other.

11. The seal member according to claim 1, wherein
the seal member is formed in an annular shape.

12. The seal member according to claim 2, wherein
the seal member is formed in an annular shape.

13. The seal member according to claim 3, wherein
the seal member is formed in an annular shape.

14. The seal member according to claim 5, wherein
the seal member is formed in an annular shape.

15. The seal member according to claim 8, wherein
the seal member is formed in an annular shape.

16. A waterproof structure, comprising:
the seal member according to claim 1, wherein
the seal member is disposed between the first member and the second member opposing to each other to tightly seal between the first member and the second member.

17. A waterproof structure, comprising:
the seal member according to claim 2, wherein
the seal member is disposed between the first member and the second member opposing to each other to tightly seal between the first member and the second member.

18. A waterproof structure, comprising:
the seal member according to claim 3, wherein
the seal member is disposed between the first member and the second member opposing to each other to tightly seal between the first member and the second member.

19. A waterproof structure, comprising:
the seal member according to claim 5, wherein
the seal member is disposed between the first member and the second member opposing to each other to tightly seal between the first member and the second member.

20. A waterproof structure, comprising:
the seal member according to claim 8, wherein
the seal member is disposed between the first member and the second member opposing to each other to tightly seal between the first member and the second member.
